(19) United States
(12) Patent Application Publication
(10) Pub. No.: US 2024/0174800 A1
(43) Pub. Date: May 30, 2024

(54) MELT-STABLE POLYLACTIDE RESIN COMPOSITIONS CONTAINING PHOSPHITE ESTERS

(71) Applicant: NatureWorks LLC, Plymouth, MN (US)

(72) Inventors: Jed Richard Randall, Minneapolis, MN (US); Samantha Leigh Thompson-Barclay, Plymouth, MN (US); Patricia America Nancy Popescu, Saint Louis Park, MN (US); Patrick Kevin Hoard, Elk River, MN (US); Joseph David Schroeder, Minneapolis, MN (US); James Russell Valentine, Chanhassen, MN (US); Manuel A.W. Natal, Eden Prairie, MN (US)

(21) Appl. No.: 18/550,583

(22) PCT Filed: Mar. 28, 2022
(86) PCT No.: PCT/US2022/022088

§ 371 Date: Sep. 14, 2023

Related U.S. Application Data
(60) Provisional application No. 63/168,751, filed on Mar. 31, 2021.

(51) Int. Cl. C08G 63/692; C08G 63/82; C08G 63/88

(52) U.S. Cl. CPC C08G 63/692; C08G 63/823; C08G 63/88

(57) ABSTRACT

Polylactide resin compositions contain certain phosphite esters. The presence of the phosphite ester increases the rate of hydrolysis of the polylactide resin under conditions of moisture (including atmospheric moisture) at mildly elevated temperatures.

This invention relates to polylactide resin compositions that hydrolyze rapidly.

Polylactide resins (PLA) are used in increasing quantities to make a wide variety of products. Among many others are packaging sheet and films; disposable food serviceware such as cutlery, cups, plates, bowls, and containers; and non-woven fabrics such as are useful for making items such as wipes and diaper linings. PLA is an attractive alternative to other polyesters such as PET because, unlike PET, PLA is compostable under certain conditions, more easily degradable, and is made industrially using lactic acid produced from annually renewable carbon sources such as corn sugars. These attributes position PLA well within circular economy concepts.

PLA is an aliphatic polyester that is well known to hydrolyze in the presence of water. The rate of hydrolysis of PLA resins having molecular weights high enough for most industrially produced products is quite slow under common storage and use conditions, where use temperatures are below the glass transition temperature (T_{g}). Although this slow hydrolysis rate is often beneficial, there are cases in which faster hydrolysis is wanted, especially at temperatures below the T_{g}. The rate of hydrolysis increases rapidly at temperatures above the T_{g}, which for PLA can range from about 45° ° C.to about 65° C.

One of these cases is the industrial composting of post-consumer PLA waste, where hydrolysis of high-molecular weight PLA articles produces brittle, low molecular weight species that disintegrate into small pieces and form low molecular weight oligomers (molecular weights <10 kg/mole). The low molecular weight oligomers eventually become microbially converted to primarily carbon dioxide, in a process called biodegradation. Without significant hydrolysis, the disintegration of PLA into smaller pieces will not occur quickly under industrial composting conditions. Since the active composting phase time in most industrial composting facilities today is decreasing, so composters can turnover their compost product for sale faster, a faster rate of disintegration of post-consumer PLA waste is desired.

Additionally, some applications for PLA seek to take advantage of its ability to be hydrolyzed, perhaps in a tunable manner. An example of such an application is as a degradable chemical diverter in an oil and/or gas production well. Diverters are used in injection treatments to ensure a uniform distribution of treatment fluid across the treatment interval. Injected fluids tend to follow the path of least resistance, possibly resulting in the least permeable regions receiving inadequate treatment. The diverter is injected into the formation with the treatment fluid. When emplaced, the diverter temporarily blocks off certain regions of the formation from the injection treatment, diverting the treatment to less permeable areas that otherwise might not become treated adequately. To be effective, the diversion effect must be temporary, so the full productivity of the well can be restored when the treatment is complete. PLA provides the needed temporary blocking effect because it hydrolyzes under the conditions of moisture and temperature in the well, forming low-molecular-weight species that either dissolve or wash away, thereby reopening the blocked region of the formation when the well goes to production. Again, hydrolytic degradation is often too slow, especially when the temperature is below the T_{g} of the PLA. In the diverter application, slow hydrolysis causes the diverter to remain in place too long.

PCT/US2020/034449 describes a relationship between the crystallinity of a polylactide resin and its rate of hydrolysis under certain conditions. More highly crystalline polylactides tend to hydrolyze relatively slowly. Because of this, so-called “amorphous” polylactide grades have been preferred when faster hydrolysis rates are wanted. “Amorphous” polylactide grades are polylactide resins that can crystallize with difficulty, if at all, and which, if crystallized at all, produce only small amounts of crystallites. In addition, the crystallites tend to be less perfectly formed and for that reason exhibit a lower melting temperature. PCT/US2020/03449 describes blends of a poly(meso-lactide), which cannot be crystallized, with an equal amount or less of a second polylactide, which may be a crystallizable grade. These blends hydrolyze rapidly and, due to the presence of the second polylactide, resist blocking. However, these blends are at most poorly crystallizable prior to being hydrolyzed. Certain applications for polylactide resin require the resin to be semi-crystalline, to provide heat stability or for other reasons.

PCT/US2020/03449 further describes adding a small amount of an organic acid such as lauric acid into a polylactide composition to further accelerate hydrolysis.

Phosphite compounds are known additives for polylactide resins. They can function as stabilizers, to reduce or prevent polymer degradation during melt- processing. See, e.g., U.S. Pat. Nos. 5,338,822 and 6,114,495.

This invention is in one aspect a polylactide resin composition comprising (a) at least one polylactide having a number-average molecular weight as measured by gel permeation chromatography against a polystyrene standard of at least 20,000 g/mol, the polylactide containing (i) 5 to 300 ppm by weight of Group 2-14 metals based on the weight of the polylactide; (ii) 0.1 to 2 parts by weight per 100 parts by weight of the polylactide of (ii-a) polymer having multiple carboxylic acid groups, a number average molecular weight of at least 500 g/mol and at least one carboxylic acid group per 250 atomic mass units and/or (ii-b) a polyphosphoric acid, which may be partially or completely neutralized, and/or residue thereof; and (iii) no more than 0.6 parts by weight of lactide per 100 parts by weight of the polylactide; and (b) at least one phosphite ester compound, the phosphite ester compound containing 3% to 15% by weight phosphorus and wherein the phosphite ester compound contains, per phosphite phosphorus atom, from zero to one aryl group in which at least one ring carbon ortho to a ring carbon bonded directly to a phosphite oxygen is directly bonded to a tertiary carbon atom of a substituent group, and the polylactide resin composition containing a sufficient amount of the phosphite ester compound to provide 0.01 to 32 g of phosphorus per kilogram (kg) of the polylactide in the polylactide resin composition.

In another aspect, the invention is also a polylactide resin composition comprising (a) at least one polylactide having a number-average molecular weight as measured by gel permeation chromatography against a polystyrene standard of at least 20,000 g/mol having dissolved or dispersed therein (b) at least one polyphosphite ester compound containing 3.5% to 15% by weight phosphorus and being represented by either of structures I and II, wherein structure I is

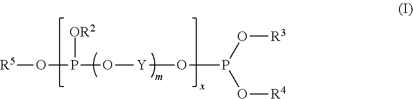

Wherein each R², R³, R⁴ and R⁵ can be the same or different and independently selected from the group consisting of C₁₋₂₀ alkyl, C₃₋₂₂ alkenyl, C₆₋₄₀ cycloalkyl, C₇₋₄₀ cycloalkylene, C₁₋₂₀ methoxy alkyl glycol ethers, C₁₋₂₀ alky glycol ethers, and/or Y—OH; Y is selected from the group consisting of C₂₋₄₀ alkylene, C₂₋₄₀ alkyl lactone, —R⁶—N(R⁷)—R⁸— wherein R⁶, R⁷, and R⁸ are independently selected from the group consisting of hydrogen, C₁₋₂₀ alkyl, C₃₋₂₂ alkenyl, C₆₋₄₀ cycloalkyl, C₇₋₄₀ cycloalkylene, C₁₋₂₀ methoxy alkyl glycol ethers, C₁₋₂₀ alky glycol ethers, and/or Y—OH, m is an integral value ranging from 2 to 100 and x is an integral value ranging from 1 to 1000; and structure II is

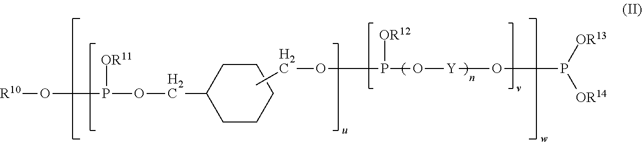

wherein R¹⁰, R¹¹, R¹², R¹³ and R¹⁴ can be the same or different are independently selected from the group consisting of C₁₋₂₀ alkyl, C₂₋₂₂ alkenyl, C₆₋₄₀ cycloalkyl, and C₇₋₄₀ cycloalkenyl; Y is selected from the group consisting of C₂₋₄₀ alkylene, C₂₋₄₀ aliphatic carboxylic acid esters, and C₃₋₄₀ cycloalkylenes, n is a number from 5 to 100, u is a number from 8 to 1000, v is a number from 1 to 1000 and w is a number from 1 to 1000, and further wherein the polylactide resin composition contains a sufficient amount of the polyphosphite ester compound to provide 0.01 to 32 g of phosphorus per kg of the polylactide in the polylactide resin composition.

The polylactide resin composition hydrolyzes rapidly compared to an otherwise like composition that lacks the phosphite ester compound, even when the polylactide component of the composition is a semi-crystalline grade that has been crystallized. Through the selection of particular phosphite compounds and their amounts in the polylactide resin composition, hydrolysis rates can be adjusted as wanted for particular applications. It is noted that, particularly in compositions of the first aspect, the phosphite ester provides little if any benefit in reducing lactide reformation, inasmuch as the PLA resin is previously treated to be highly melt-stable.

In a third aspect, the invention is a method of making a polylactide resin composition, comprising the steps of:
a) polymerizing lactide in the presence of a Group 2-14 metal-containing catalyst to produce a crude polylactide containing 5 to 300 ppm by weight of Group 2- 14 metals based on the weight of the polylactide;
b) combining the crude PLA resin with a 0.1 to 2 parts by weight per 100 parts of the polylactide of (i) a polymer having multiple carboxylic acid groups, a number- average molecular weight of at least 500 g/mol, and at least one carboxylic acid group per 250 atomic mass units, and/or (ii) a polyphosphoric acid, which may be partially or completely neutralized, and/or residue thereof;
c) before, simultaneously with, or after step a), devolatilizing the crude polylactide resin to reduce the lactide concentration to no greater than 0.6% of the combined weight of the polylactide and the remaining lactide; and then
d) after step b), combining the PLA resin with at least one phosphite ester compound containing 3% to 15% by weight phosphorus and wherein the phosphite ester compound contains, per phosphite phosphorus atom, from zero to one aryl group in which at least one ring carbon ortho to a ring carbon bonded directly to a phosphite oxygen is directly bonded to a tertiary carbon atom of a substituent group, in an amount sufficient to provide 0.01 to 32 g of phosphorus per kg of the polylactide in the polylactide resin composition.

The phosphite ester compound contains one or more phosphite ester groups. In some embodiments, the phosphite ester compounds contains exactly one phosphite ester group. In other embodiments, the phosphite ester is or includes one or more materials that has at least 2, at least 3, at least 4, or at least 6 phosphite groups and up to 97, up to 50, or up to 25 phosphite groups. Mixtures of phosphite esters are useful. In some embodiments, the phosphite ester is a polymeric material.

“Phosphite ester groups” are represented by the structure P(OR)3, where each R is an unsubstituted or substituted hydrocarbyl group that forms a carbon-oxygen bond to the corresponding phosphite oxygen. A substituted R group contains one or more heteroatoms (i.e., atoms other than hydrogen and carbon, such as phosphorus, nitrogen, and oxygen). For example, any group R may include one or more ether, ester, or carbonyl groups. When the phosphite ester compound contains more than one phosphite ester group, at least one R group is polyvalent, forming carbon-oxygen bonds to oxygen atoms of two or more phosphite groups. Two or more R groups may together form a ring structure that includes the phosphorus atom and two or more oxygen atoms of the phosphite ester group. The organic groups R each may contain, for example, 1 to 50 carbon atoms and have a formula weight of, for example, 15 to 1000 g/mol.

The phosphite ester compound contains 3.5% to 15% by weight phosphorus, based on its total weight. In some embodiments, it contains 4% to 12% or 4% to 10% by weight phosphorus. Preferably, at least 80%, at least 90%, or at least 93% of the phosphorus in the phosphite ester compound is in one or more phosphite groups. All the phosphorus may be in phosphite form. Any remaining phosphorus, when present, may be contained in other types of groups such as, for example, phosphate and/or phosphonate.

The phosphite ester compound has a number-average molecular weight of up to 5,000 g/mol, preferably up to 3,000 g/mol, or up to 2,000 g/mol. For purposes of this invention, the molecular weight of a non-polymeric phosphite ester of defined structure is its formula weight. For polymeric phosphite esters, the molecular weight is an apparent number-average molecular weight measured by gel permeation chromatography against polystyrene standards.

The phosphite ester preferably is not crosslinked and does not contain gels. The phosphite ester preferably is a liquid at 25° C. or a solid having a melting temperature of 100° C. or below.

Any group R may be, for example, linear alkyl, branched chain alkyl, cycloaliphatic, aryl, or any combination of any two or more thereof, any of itself which, may be unsubstituted or substituted with one or more heteroatoms as described before. In some embodiments, one or more of the organic groups R is a linear, branched chain, and/or cyclic, mono- or polyvalent alkyl group having 4 to 24 carbon atoms, especially 8 to 18 carbon atoms. One or more groups R may be, for example, a monovalent linear or branched alkyl group having 12 to 16 carbon atoms.

The phosphite ester contains no more than one R group per phosphite phosphorus atom that is an aryl group such as phenyl, in which at least one ring carbon, ortho to the ring carbon bonded directly to an oxygen atom of the phosphite group, is directly bonded to a tertiary carbon atom of a substituent group (such as, for example, a tert-butyl group). The phosphite ester may contain fewer than one such R groups, or even no such R groups, per phosphite phosphorus atom. Phosphite esters having more than one such R group per phosphite phosphorus atom typically do not increase hydrolysis rates and may even decrease them.

In yet other embodiments, one or more R groups is an unsubstituted aryl group such as phenyl, or an aryl group (again such as phenyl) substituted with one or more straight chain alkyl groups such as a Ci to Cis straight-chain alkyl group.

A polyvalent organic group R bonded to two or more phosphite ester groups may be, for example, a polyvalent linear, branched chain, and/or cyclic group, and as before may contain one or more ether linkages. Polyvalent organic groups R may have a formula weight of, for example, 14 to 1000 g/mol, especially 50 to 750 or 50 to 500 g/mol. Specific examples of polyvalent organic groups R include linear or branched Cz to C24 alkylene, especially C6 to C18 alkylene.

Specific examples of phosphite esters having 1 or 2 phosphite groups include bis(2,4-di-t-butylphenyl)pentaerythritol diphosphite (C₃₃H₅₀O₆P₂, formula weight 604), bis(2,4-dicumylphenyl) pentaerythritol diphosphite (C₅₃H₅₈O₆P₂, formula weight 852), bis (octadecyl)pentaerythritol diphosphite (C₄₁H₈₂O₆P₂, formula weight 732), triphenyl phosphite (C₁₈H₁₅O₃P, formula weight 310), tridecyl phosphite (C₃₀H₆₃O₃P, formula weight 502), didecyl phenyl phosphite (C₂₆H₄₇O₃P, formula weight 438), phenyl neopentylene glycol phosphite ester (C₁₁H₁₅O₃P, formula weight 226), and tris(4-nonylphenyl) phosphite (C₄₅H69O₃P, formula weight 688).

In some embodiments, the phosphite ester is or includes at least one compound having structure I or structure II as set forth above. Phosphite esters having structures I or II have been found to provide much larger increases (compared to other phosphite esters) in hydrolysis rate when the hydrolysis is performed in liquid water at a temperature of, for example, 25° C. to 80° C. Such phosphite esters are described in, for example, U.S. Pat. No. 8,563,637 and U.S. Pat. No. 8,981,042. In some embodiments, such a phosphite ester is a room-temperature (25° C.) liquid, alkylphenyl-free polymeric polyphosphite having a Brookfield viscosity of 500 to 2500 centipoises at 25° C. and which contains 5% to 15%, especially 7% to 12%, by weight phosphorus. Its weight-average molecular weight by gel permeation chromatography against linear polystyrene standards may be, for example, 1000 to 30,000 g/mol. Examples of such phosphite esters include those sold by Dover Chemical as Doverphos® LGP-11 and Doverphos® LGP-12.

The polylactide (PLA) component of the inventive composition is a polymer containing repeating lactic (—O—CH(CH₃)—C(O)—) units. The lactic units may be L-lactic units, D-lactic units, or both L- and D-lactic units. The ratio of L- to D-lactic units in the polylactide may range from 100:0 to 0:100. In some embodiments, this ratio is ≥ 92:8 or ≥8:92, in which case the PLA is a crystallizable grade that can under appropriate conditions be crystallized to form a semi-crystalline article. By a “crystallizable grade”, it is meant the PLA contain greater than 5 J/g of crystallites, and more preferably at least 15 J/g of crystallites, after being heated at 110° C. in air for one hour. The sample is previously heated to at least 220° C. to melt any crystallites and then quenched by rapidly cooling to room temperature (23±3° C.). The quenched sample is then heated at 110° C. for one hour and again quenched by cooling to room temperature. Crystallinity is then conveniently measured using differential scanning calorimetry (DSC) methods. The amount of such crystallinity is expressed herein in terms of J/g, i.e., the enthalpy of melting, in Joules, of the polylactide crystals in the sample divided by the weight in grams of polylactide(s) in the sample. A convenient test protocol for making DSC measurements is to heat a 5-10 milligram sample from 25° C. to 225° C. at 20° C./minute under nitrogen on a Mettler Toledo DSC 3+ calorimeter running STARe V.16 software, or equivalent apparatus.

In other embodiments, this ratio is <92:8 and >8:92, especially <88:12 and >12:88, in which case the PLA is an amorphous grade. By an “amorphous grade”, it is meant the PLA contains no more than 5 J/g of crystallites after being heated at 110° C. in air for one hour, using the test protocol described in the preceding paragraph. An example of an amorphous grade is a random copolymer of a mixture of at least 80% by weight meso-lactide with up to 20% by weight of one or both of L- and D-lactide.

In particular embodiments, the ratio of L- to D- lactic units is ≥95:5 or ≤5:95, producing a crystallizable PLA grade. An advantage of this invention is that the polymer hydrolyzes rapidly even when the PLA is semi-crystalline, having, for example, 15 J/g or more of PLA crystallites. When L-lactic units and D-lactic units are both present in the PLA, it is preferred that they are arranged randomly.

In a particular embodiment, the PLA is a homopolymer of L-lactide or a random copolymer of L-lactide with one or more of meso-lactide, D-lactide, and rac-lactide.

The remaining weight of the PLA (if any) may include residues of an initiator compound and/or repeating units produced by polymerizing one or more monomers different from lactide. Suitable such initiators include, for example, water, alcohols, polyhydroxy compounds of various types (such as ethylene glycol, propylene glycol, polyethylene glycol, polypropylene glycol, other glycol ethers, glycerin, trimethylolpropane, pentaerythritol, hydroxyl-terminated butadiene polymers, and the like), polycarboxyl-containing compounds, and compounds having at least one carboxyl group and one hydroxyl group (such a lactic acid or lactic acid oligomer). The initiator residue preferably constitutes no more than 5%, and especially no more than 2%, of the weight of the PLA, except in the case in which the initiator is a residue of a lactic acid or lactic acid oligomer, which can constitute any proportion of the PLA.

The PLA may be a copolymer of lactic acid and/or one or more lactides with one or more copolymerizable monomers. Other monomers that can be copolymerized with lactic acid and/or lactide to produce the PLA include alkylene oxides (including ethylene oxide, propylene oxide, butylene oxide, tetramethylene oxide, and the like), cyclic lactones such as caprolactone, alpha- and/or beta hydroxy acids such as 3-hydroxybutanoic acid and 4-hydroxybutanoic acid, and carbonates. Repeating units derived from these other monomers can be present in block and/or random arrangements. These other repeating units in some embodiments constitute up to 50% by weight of the PLA, preferably from 0% to 10% by weight, especially from 0% to 5% or 0% to 2% by weight of the PLA, and may be absent.

The PLA may be a block and/or graft copolymer produced by polymerizing lactide onto a polymeric initiator, particularly a polyester initiator such as polycaprolactone or a caprolactone-butanediol adduct, polymers and copolymers of butyl succinate, polybutylene adipate-co-terephthalate, polybutylene sebacate-co-terephthalate, polybutylene succinate-co-terephthalate, and the like. In such a case, lactic units in some embodiments may constitute at least 50% of the total weight of the PLA, preferably 75% to 95% by weight thereof.

The PLA may also be a product that contains at least 50% lactic units produced by transesterifying a polylactide with another polyester such as polycaprolactone, polymers and copolymers of butyl succinate, polybutylene adipate-co-terephthalate, polybutylene sebacate-co-terephthalate, polybutylene succinate-co-terephthalate, and the like.

The PLA may be linear or may have long-chain branches (having 3 or more carbon atoms). Long-chain branches can be introduced in the polylactide in various ways, such as by reacting carboxyl groups on the polylactide with epoxide groups that are present on an acrylate polymer or copolymer. The acrylate polymer or copolymer is characterized in being a solid at 23ºC, containing an average of from about 2 to about 15 free epoxide groups/molecule (such as from about 3 to about 10 or from about 4 to about 8 free epoxide groups/molecule), and being a polymerization product of at least one epoxy-functional acrylate or methacrylate monomer, preferably copolymerized with at least one additional monomer. The acrylate polymer or copolymer suitably has a number-average molecular weight per epoxide group of about 150 to about 700 g/mol, such as from 200 to 500 or from 200 to 400 g/mol. The acrylate polymer or copolymer suitably has a number-average molecular weight of from 1000 to 6000 g/mol, such as from about 1500 to 5000 g/mol or from about 1800 to 3000 g/mol. Other approaches to introducing long-chain branching are described in U.S. Pat. Nos. 5,359,026 and 7,015,302, and in WO 06/002372A2.

In preferred embodiments, the PLA lacks long-chain branches.

The PLA has a number-average molecular weight as measured by gel permeation chromatography against a polystyrene standard of at least 20,000 g/mol. The number-average molecular weight may be at least 30,000 or at least 50,000 g/mol, and may be up to, for example, 500,000, up to 250,000, or up to 130,000 g/mol.

The PLA in some embodiments is characterized by having a relative viscosity of 1.1 to 6, such as 1.25 to 5, or 1.5 to 4.1, measured using a 1% wt/vol solution of the polylactide resin in chloroform against a chloroform standard on a capillary viscometer at 30° C.

The polylactide component of the inventive composition may be a mixture of two or more different PLA resins. For example, the polylactide component may include one or more crystallizable PLA grades and one or more amorphous PLA grades.

The PLA is conveniently formed by polymerizing lactide. The lactide may be L-lactide, D-lactide, meso-lactide, a mixture of any two or more thereof, or rac-lactide (which is a 50/50 mixture of L- and D-lactide). Lactic units preferably constitute at least 90% or at least 95% by weight of the PLA. A suitable polymerization temperature preferably is above the melting temperature of the monomer or monomer mixture, but below the temperature at which significant polymer degradation occurs. The temperature range may be, for example, as low as 60° C. or as high as 225° C.

Molecular weight and conversion are controlled by polymerization time and temperature, the equilibrium between free lactide and the polymer, and by the use of initiator compounds. In general, increasing quantities of initiator compounds on a molar basis will tend to decrease the molecular weight of the product polymer. Molecular weight control agents such as described in U.S. Pat. No. 6,277,951 can also be added to obtain the desired molecular weight. The residence time under polymerization conditions is selected to produce a polymer of the desired molecular weight and/or desired conversion of monomers.

It is preferred to perform the polymerization in the presence of a polymerization catalyst, which preferably contains at least one Group 2-14 metal. Examples of these catalysts include various tin compounds such as SnCl₂, SnBr₂, SnCl₄, SnBr₄, SnO, tin (II) bis(2-ethyl hexanoate), butyltin tris(2-ethyl hexanoate), hydrated monobutyltin oxide, dibutyltin dilaurate, tetraphenyltin, and the like; PbO, zinc alkoxides, zinc stearate, compounds such as aluminum alkoxides, compounds such as antimony triacetate and antimony (2-ethyl hexanoate), compounds such as bismuth (2-ethyl hexanoate), calcium stearate, magnesium stearate, certain yttrium and rare earth compounds such as are described in U.S. Pat. No. 5,208,667 to McLain et al., chiral (R)-(SalBinap)-AIOCH3 complexes as described in Macromol. Chem. Phys. 1996, 197, 2627-2637, single-site B-diimidate zinc alkoxide catalysts as described in JACS 1999, 121, 11583-11584, lithium t-butoxide aggregates as described in Macromolecules 1995, 28, 3937-3939 and Polymer 1999, 40, 5455-5458; aluminum and yttrium-based catalyst complexes as described in JACS 2002, 124, 1316-1326, dinuclear indium catalysts as described in Macromolecules 2016, 49, 909-919, and the like. Catalysts are used in catalytically effective amounts, which depend somewhat on the particular catalyst, but are usually in the range of 1 mole of catalyst per 3000 to 50,000 moles of monomers.

A PLA resin resulting from such a polymerization typically contains metal catalyst residues. In certain embodiments of this invention, the PLA resin contains 5 to 300 ppm by weight of Group 2-14 (IUPAC Periodic Table of the Elements, 1 Dec. 2018), which Group 2-14 metals may include such metal catalyst residues. In particular, the PLA resin may contain 5 to 300 ppm of tin, based on the weight of the PLA resin, especially 5 to 200 ppm of tin, which may include or be residues of a tin polymerization catalyst.

The PLA may contain lactide, which may include residual lactide that is not consumed during the polymerization. If lactide is present, then the PLA may contain up to 20%, up to 15%, up to 10%, up to 5%, or up to 2% of the lactide, based on the weight the weight of the PLA plus the lactide. In certain embodiments, the PLA contains no more than 0.6% or no more than 0.3% by weight lactide, on the same basis.

In certain embodiments, particularly when the PLA resin contains Group 2 to 14 metals, the PLA resin also may include 0.1 to 2 parts by weight per 100 parts by weight of the polylactide of (a) a polymer having multiple carboxylic acid groups, a number average molecular weight of at least 500 g/mol and at least one carboxylic acid group per 250 atomic mass units and/or (b) a polyphosphoric acid or residue thereof. Examples of polymers having multiple carboxyl groups include polymers and copolymers of acrylic acid as described in U.S. Pat. No. 6,114,499, including acrylic acid homopolymers, copolymers of ethylene and acrylic acid, and copolymers of styrene and acrylic acid. Further examples of such polymers include copolymers of acrylic acid and an acrylic acid ester or a methacrylic acid ester, as well as polymers and copolymers of acrylic acid in which a portion of the acrylic acid repeating units in the polymer or copolymer are esterified to product alkyl or substituted alkyl ester, as described in U.S. Pat. No. 8,114,939. Such polymers include polymers containing acrylic acid repeating units and alkyl (or substituted alkyl) acrylate repeating units, and from 0 to 10 mole percent of repeating units from one or more other monomers, wherein ethyl acrylate groups may constitute up to 50 mole percent of the repeating units of the polymer, methyl acrylate groups may constitute from 2 to 30 mole percent of the repeating units of the polymer, and alkyl acrylate groups that contain from 2 to 8 carbon atoms in the ester group constitute from 2 to 25 mole percent of the repeating units of the polymer.

Polyphosphoric acids, for purposes of this invention, are linear, branched or cyclic compounds having at least one

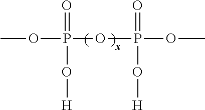

moiety, wherein x is zero or one. The polyphosphoric acid may be partially or entirely neutralized, in which case the hydrogens indicated in the foregoing structure are replaced with a monovalent cation such as alkali metal or ammonium.

Suitable polyphosphoric acids include pyrophosphoric acid, triphosphoric acid, tetraphosphoric acid, penta- and higher polyphosphoric acids, hypophosphoric acid, metaphosphoric acid, and mixtures of any two or more thereof. A polyphosphoric acid may have P₂O₅ concentration of at least 68%, at least 75% or at least 80% and, for example, up to 90% or up to 87% by weight as measured by titration. A polyphosphoric acid may have a calculated phosphoric acid concentration of at least 105% or at least 110% and, for example, up to 125% or up to 120% by weight. A commercial polyphosphoric acid grade having a P₂O₅ concentration of 82% to 87% by weight, especially 83 to 85% by weight, and a calculated phosphoric acid concentration of 110% to 120%, especially 114 to 118%, is suitable. “Residues” of such a polyphosphoric acid refer to phosphorus-containing reaction and/or decomposition product of the polyphosphoric acid. Such residues in general do not contain phosphite ester compounds.

The polylactide resin composition contains sufficient of the phosphite ester compound to provide 0.01 to 32 g of phosphorus per kg of the polylactide in the polylactide resin composition (i.e., the phosphite ester itself provides 0.5 to 32 g of phosphorus per kg of the polylactide; other phosphorus may be present from other sources, such as a polyphosphoric acid). A preferred amount is at least 0.015 g P/kg, at least 0.075 g P/kg, or at least 0.15 g P/kg. A preferred upper amount is up to 10 g P/kg, up to 5 g P/kg, or up to 0.5 g P/kg. Polylactide compositions containing high amounts of the phosphite ester compound may be produced as concentrates (masterbatches) which can be let down into more PLA to produce a final polylactide resin composition having a lower concentration of the phosphite ester compound.

The polylactide resin composition of the invention is conveniently prepared by melt- or solution blending, with melt-blending being particularly suitable. Melt-blending of the components can be performed as part of the manufacturing process for the PLA, while the PLA remains in a molten state; the phosphite ester can be added into the manufacturing process at any time during or after the polymerization of the lactide(s) to produce the PLA and after the polymer having multiple carboxyl groups and/or the polyphosphoric acid is combined with the PLA. The phosphite ester can be combined before, simultaneously with, or after devolatilizing and/or stabilizing the PLA.

In a particularly preferred process, the PLA is produced by polymerizing lactide in the presence of a metal-containing catalyst as described above to produce a crude polymer containing residual metals from the catalyst. The crude polymer is then combined with a polymer having multiple carboxylic acid groups as described above, preferably by melt blending, and before, simultaneously with or after being combined with the polymer having multiple carboxylic acid groups, is devolatilized and stabilized to reduce the lactide concentration, preferably to no greater than 0.6% or no greater than 0.3% of the combined weight of the PLA and the remaining lactide. The steps of combining the crude polymer with the polymer having multiple carboxylic acid groups and the devolatilization and/or stabilization step(s) are conveniently performed with the PLA in the molten state and can be performed immediately after the polymerization step without an intermediate step of cooling the PLA to form a solid. The so-treated PLA is thereafter combined with the phosphite compound, preferably by melting the PLA and combining the phosphite compound with the molten PLA or by solution-blending; this can be performed as part of the manufacturing process or in a subsequent operation. Melt-blending, when performed in a separate operation, can be performed in any convenient apparatus such as a single- or twin-screw extruder, a kneader, or other apparatus.

No special conditions are necessary to perform the melt-blending other than an elevated temperature sufficient to heat-soften the PLA followed by phosphite addition and mixing. A crystallizable PLA grade should be heated above its crystalline melting temperature. A temperature of 180° C. to 250° C. is suitable.

The polylactide resin composition may be made in two or more steps by, in forming in a first step a blend of the PLA resin and a somewhat high amount of the phosphite composition (a “concentrate” or “masterbatch”), and then letting the concentrate or masterbatch down with more PLA resin to form a final composition. The concentrate or masterbatch may contain, for example, enough of the phosphite ester compound to provide 0.5 to 32 g of phosphorus per kg of the polylactide (i.e., the phosphite ester itself provides 0.5 to 32 g of phosphorus per kg of the polylactide; other phosphorus may be present from other sources, such as a polyphosphoric acid). The steps of producing a concentrate or masterbatch and letting it down each can be performed by melt- or solution-blending methods, with melt-blending methods as described before being particularly suitable.

The polylactide resin composition may contain other materials as may be useful for the particular end-use application in which it will be used. These may include, for example, polymers other than polylactides, i.e., a non-polylactide polymer. Such a polymer may be hydrolyzable and/or biodegradable by itself. In such a case, the polymer may function at least in part to further modify the hydrolytic behavior or the polylactide composition. Suitable such hydrolyzable polymers include polymers or copolymers of glycolide or glycolic acid (which when present may accelerate the hydrolysis and mass loss rate of the polylactide resin composition), polycaprolactone, polymers and copolymers of butyl succinate, polybutylene adipate-co-terephthalate, polybutylene sebacate-co-terephthalate, polybutylene succinate-co-terephthalate, and the like.

A non-polylactide polymer, if present, may constitute, for example, 0.1% to 90%, 1% to 50%, 1% to 25%, or 1% to 10%, of the combined weight of the non-polylactide polymer and the polylactides.

Other optional materials that may be present in the polylactide resin composition include crystallization nucleators such as finely divided solids; colorants; impact modifiers; internal and/or external lubricants, anti-block, and other extrusion processing aids; and the like. The polylactide resin composition of the invention can be compounded with various types of reinforcing fillers or fibers to produce reinforced composites.

The polylactide resin composition may be expanded to reduce its density below the bulk density of the polylactides. This may be done, for example, via various extrusion processes in which a melt of the polylactides is combined with a blowing agent under pressure. The melt is then transferred to a region of lower pressure such that the blowing agent volatilizes as the polylactides cool, thereby expanding the composition. Other foaming methods, such as various frothing and bead foaming methods, can be used. A solid blend polylactide resin composition with a fugitive material compound can be prepared, followed by removal of the fugitive material to produce voids in the composition. The reduced density may be at least 0.05 g/cm³, at least 0.25 g/cm³, or at least 0.5 g/cm³ and, for example, up to 1.2 g/cm³, up to 1.1 g/cm³, up to 1 g/cm³, or up to 0.9 g/cm³. Reducing density in some cases provides desirable buoyancy characteristics.

The polylactide resin composition is useful in the same manner as otherwise like polylactide compositions that do not contain the phosphite ester compound. It can be melt-processed via processes such as extrusion, extrusion foaming, blow molding, injection stretch blow molding, thermoforming, injection molding, melt (fibre) spinning, lamination, and the like. It can be formed into various dispersions for coating applications. Applications of particular interest are those in which the polylactide resin composition is desired to hydrolyze, either during use (such as in oil and/or gas well treatment diverter or similar applications) or after use (such as upon disposal, for example, in landfill or composting environments). Examples of items that are commonly landfilled and/or composted include food serviceware such as cutlery, plates, bowls, cups, rigid containers such as foamed or unfoamed packaging material (including, for example, clamshell packaging), tea bags, coffee and other liquid capsules, bottles, and other food packaging or storage items. Other examples of disposable items include wipes, towels, diapers, face coverings, and the like. The polylactide resin composition of the invention is useful for making all of these items.

The polylactide resin composition of the invention can be hydrolyzed by exposure to liquid water (or other aqueous fluid), steam, and/or atmospheric humidity. During hydrolysis, the polylactide resin composition may be, for example, immersed in or otherwise in contact with liquid water (or other aqueous fluid) or contacted with steam or humid air. The temperature affects hydrolysis and mass loss rates, with higher temperatures leading to higher rates. The temperature may be, for example, above 0° C. to 100° C., or even higher if superatmospheric pressures are employed to prevent liquid water from boiling, or when the hydrolysis is affected by the presence of steam. In some embodiments, such as composting applications, the temperature may be, for example, 25° C.to 80° C., especially 35° C. to 80° C., 35° C. to 70° C., 40° C. to 70° C., or 40° C. to 65° C., and water is present in the form of liquid water and/or atmospheric humidity. Hydrolysis in such applications can be performed, for example, at such temperatures and in the presence of air at a relative humidity of at least 50%, at least 70%, or at least 80%, up to 100% or even more if the air is supersaturated. The exposure to liquid water (or other aqueous fluid), steam, and/or atmospheric humidity may be maintained for a period of at least one day, at least 7 days, at least 14 days, or at least 30 days.

The rapid rate of hydrolysis, and mass loss (when hydrolysis takes place on compositions submersed in water), exhibited by the polylactide resin composition of the invention, particularly at low to moderately elevated temperatures such as 40° C.to 70° C., is an important advantage of this invention.

In oil and gas well treatment operations, the polylactide resin composition is introduced into the well in particulate form, together with a treatment fluid. The particulates may have varying dimensions. The treatment fluid is typically aqueous. The treatment fluid will generally take the path of least resistance as it flows within the formation. The polylactide resin composition is carried with the treatment fluid and bridges a fracture, thereby providing a physical barrier to further flow of the treatment fluid through those sections in which the diverter has deposited. Further flow of the treatment fluid is therefore forced into otherwise less-accessible regions of the formation. The primary reason for using degradable diverters is to increase the stimulated reservoir volume of a given formation.

The diverter should remain in place only temporarily so as not to block the recovery of hydrocarbons through those sections of the formation occupied by the diverter. Accordingly, the diverter is subjected to hydrolysis conditions while emplaced in the formation by exposure to water, and preferably an elevated temperature. The elevated temperature may be, for example, 40° C.to 66° C., 48° C. to 66° C., or 48° C.to 60° C. The hydrolysis conditions may be maintained, for example, until at least 50%, at least 60%, at least 70%, at least 75%, at least 80%, or at least 85% of the starting mass of the polylactide resin composition has been lost due to hydrolysis (the lost mass having become dissolved into and/or transported away by the water). This may require, for example, at least 1, at least 2, at least 5, at least 8, at least 10, or at least 14 days in some embodiments, depending on factors such as the particular polylactide resin, the amount of the phosphite ester compound, and the hydrolysis conditions.

In some embodiments, a diverter comprising a particulate polylactide resin composition of the invention exhibits a tiz (time to achieve 50% mass loss) of no more than 20 days, no more than 15 days, no more than 12 days, or no more than 10 days, when hydrolyzed by submersing the particles in deionized water in a closed vial at a temperature of 60° C. (140° F.). The tiz preferably is at least 1, at least 2, at least 5, or at least 8 days according to this testing protocol.

The polylactide resin composition can be composted under temperature and moisture conditions as described above. The degradation of the polylactide composition in composting operations and to some extent in landfilling situations involves a hydrolysis step, during which the PLA breaks down into oligomers and/or lactic acid, and a subsequent biodegradation step in which the lactic acid and oligomers are consumed by microorganisms, producing carbon dioxide, water, and humus. Thus, composting is performed in the presence of microorganisms that can metabolize lactic acid, in particular thermophilic microorganisms that can tolerate the high composting temperatures. The hydrolysis and biodegradation of polylactide resin compositions of the invention takes place rapidly, as indicated by the reduction of molecular weight and the rate of CO₂ production, respectively.

Although the invention is not limited to any theory, it is believed that the phosphite ester is stable during melt processing but degrades in the presence of liquid and/or atmospheric water, through hydrolysis, oxidation, and/or other mechanism, to form acidic species. These acidic species are believed to catalyze the PLA hydrolysis reaction(s). The phosphite ester compound in the polylactide composition hydrolyzes slowly at room or slightly elevated temperatures, so the composition of the invention exhibits the further advantage of degrading slowly if at all until exposed to conditions of elevated temperatures and moisture as described above. Thus, the composition of the invention and articles made from the composition have good shelf lives and exhibit excellent hydrolytic stability until such time as they are exposed to conditions that promote rapid hydrolysis.

The following examples illustrate the invention but are not intended to limit it in any way. All parts and percentages are by weight unless otherwise indicated.

Phosphite Ester 1 is an alkylphenyl-free, room-temperature liquid, polymeric polyphosphate as generally described in U.S. Pat. No. 8,981,042 and having a structure corresponding to Structure II. It contains about 7.3% by weight phosphorus and is a room temperature liquid sold by Dover Chemical as Doverphos® LGP-12.

Phosphite Ester 2 is an alkylphenyl-free, room temperature liquid, polymeric polyphosphate as generally described in US Patent No., 8,563,637 and having a structure corresponding to Structure I, Phosphite Ester 2 has a phosphorus content between 3 to 15% and is sold by Dover Chemical as Doverphos® LPG-11.

Phosphite Ester 3 is bis(octadecyl)pentaerythritol diphosphite. It has a formula weight of 732 g/mol and contains 8.5% phosphorus.

Phosphite Ester 4 is bis(2,4-di-t-butylphenyl) pentaerythritol diphosphite. It has a formula weight of 604 g/mol and contains 10.2% phosphorus. One substituent on each phosphite group is an aryl group that is bonded to a tertiary carbon atom in the position ortho to the carbon atom bonded to the corresponding phosphite oxygen.

Phosphite Ester 5 is bis(2,4-dicumylphenyl)pentaerythritol diphosphite. It has a formula weight of 852 g/mol and contains 7.3% phosphorus. Each phosphite group is bonded directly to a phenyl group that is bonded to a tertiary carbon atom in the position ortho to the carbon atom bonded to the corresponding phosphite oxygen.

Phosphite Ester 6 is triphenyl phosphite. It has a formula weight of 310 g/mol and contains 10.0% phosphorus.

Phosphite Ester A is tris(2,4-di-t-butylphenyl) phosphite. It has a formula weight of 646 g/mol and contains 4.8% phosphorus. This compound contains a single phosphorus atom and three phenyl groups that each are bonded to a tertiary carbon atom in the position ortho to the carbon atom bonded to the corresponding phosphite oxygen. PLA Resin 1 is a linear copolymer of L-lactide, D-lactide, and meso-lactide. It contains >95% lactic units. Approximately 4.25% of the lactic units are D-lactic units; it is a semi-crystalline grade easily capable of being crystallized. PLA Resin 1 has a relative viscosity of 4. The number-average molecular weight of PLA Resin 1 is about 99,000 g/mol. The weight-average molecular weight (M_{w}) of PLA Resin 1 is about 209,000 g/mol. PLA Resin 1 is made by polymerizing the lactides in the presence of a tin-based catalyst. It contains 5 to 300 ppm by weight of Group 2-14 metals based on the weight of the polylactide, mainly tin. After polymerization, 0.1 to 2 parts by weight per 100 parts by weight of the polylactide of a polyacrylic acid having a number average molecular weight of greater than 500 g/mol is combined with the molten polymer and the molten polymer is subsequently devolatilized to reduce the residual lactide concentration to below 0.3% by weight.

PLA Resin 2 is a linear copolymer of L-lactide, D-lactide, and meso-lactide. It contains >99% lactic units. Approximately 4.4% of the lactic units are D-lactic units; it is a semi-crystalline grade easily capable of being crystallized. The number-average molecular weight of PLA Resin 2 is 52,000 g/mol. The weight-average molecular weight (M_{w}) of PLA Resin 2 is 94,000 g/mol. PLA Resin 2 is made by polymerizing the lactides in the presence of a tin-based catalyst. It contains 71.4 ppm tin and negligible amounts of other Group 2-14 metals. After polymerization, about 135 parts per million of a polyphosphoric acid (115% H3PO4 basis) are combined with the molten PLA Resin 2 and PLA Resin 2 is devolatilized to reduce residual lactide to 0.23% by weight.

PLA Resin 3 is a linear, crystallizable grade of PLA resin containing >95% lactic units, of which about 4% are D-lactic units. Its number-average molecular weight is 100,000 g/mol and its weight-average molecular weight is 200,000 g/mol. PLA Resin 3 contains 0.22% by weight residual lactide. It contains 30.6 ppm tin and negligible quantities of other Group 2-14 metals. PLA Resin 3 contains 27.1 ppm of phosphorus in the form of polyphosphoric acid and/or residues thereof.

PLA Resin 4 is a linear, amorphous grade of PLA resin made by copolymerizing a mixture of approximately 90% meso-lactide and 10% L-lactide. The Mn of PLA Resin 4 is about 78,000 g/mol, while the Mw is about 156,000 g/mol, by GPC against polystyrene standards. PLA Resin 4 contains 30-100 ppm tin and negligible quantities of other Group 2-14 metals. After polymerization, 0.1 to 2 parts by weight per 100 parts by weight of the polylactide of a polyacrylic acid having a number average molecular weight of greater than 500 g/mol is combined with the molten polymer and the molten polymer is subsequently devolatilized to reduce the residual lactide concentration to below 0.3% by weight.

### Examples 1-15 and Comparative Samples A-C

Examples 1-15 and Comparative Samples B and C are prepared by melt-blending PLA Resin 1 with a phosphite ester compound (as indicated in Table 1) in a twin-screw extruder. The amount of phosphite ester compound is selected to provide phosphorus levels in the product as indicated in Table 1 below. Comparative Sample A is prepared by passing a sample of PLA Resin 1 through the twin-screw extruder under the same operating conditions but without any additive.

TABLE 1

| Sample | Phosphite Additive | mmol P/kg | g P/kg |
|---|---|---|---|
| A* | None | 0 | 0 |
| 1 | Phosphite Ester 1 | 2.36 | 0.07 |
| 2 | Phosphite Ester 1 | 11.79 | 0.365 |
| 3 | Phosphite Ester 1 | 117.9 | 3.65 |
| 4 | Phosphite Ester 2 | 2.36 | 0.07 |
| 5 | Phosphite Ester 2 | 11.82 | 0.366 |
| 6 | Phosphite Ester 2 | 118.2 | 3.66 |
| 7 | Phosphite Ester 3 | 11.79 | 0.365 |
| 8 | Phosphite Ester 3 | 122.9 | 3.81 |
| 9 | Phosphite Ester 4 | 11.9 | 0.369 |
| 10 | Phosphite Ester 4 | 115.7 | 3.58 |
| 11 | Phosphite Ester 5 | 11.79 | 0.365 |
| 12 | Phosphite Ester 5 | 117.2 | 3.64 |
| 13 | Phosphite Ester 6 | 2.36 | 0.07 |
| 14 | Phosphite Ester 6 | 11.79 | 0.365 |
| 15 | Phosphite Ester 6 | 112.4 | 3.49 |
| B* | Phosphite Ester A | 11.79 | 0.365 |
| C* | Phosphite Ester A | 116.0 | 3.59 |

*Not an example of the invention.

5 The various materials are subjected to hydrolysis to determine relative rates of hydrolysis. The hydrolysis rate of Comparative Sample A is assigned a relative value of 1.0. The weight-average molecular weight of a sample of each material is measured by GPC relative to polystyrene standards. A portion of each sample is placed in an open aluminum container and subjected to conditions of 50° C. and 80% relative humidity (RH) in a humidity chamber. A sample is removed every 48 hours for 10 molecular weight measurement. The removed sample is first dried in a vacuum oven at 40° C. for 24 hours to remove water and thereby stop any further hydrolysis, and then evaluated by GPC. The slope of the natural logarithm of the molecular weight versus time is evaluated, and a relative (compared to Comparative Sample A) rate of hydrolysis is calculated. Higher numbers indicate faster hydrolysis. Results are as indicated in Table 2.

TABLE 2
Hydrolysis Data in Humidity Chamber at 50° C. and 80% RH

| | | | Starting | Slope | Relative |
|---|---|---|---|---|---|
| | | g | Mw | Ln(M_{w})/ | Hydrolysis |
| Sample | Phosphite Additive | P/kg | (g/mol) | day | Rate |
| A* | None | 0 | 208,737 | −0.0432 | 1.00 |
| 1 | Phosphite Ester 1 | 0.07 | 204,910 | −0.0796 | 1.84 |
| 2 | Phosphite Ester 1 | 0.365 | 173,644 | −0.1404 | 3.25 |
| 3 | Phosphite Ester 1 | 3.65 | 206,589 | −0.1637 | 3.79 |
| 4 | Phosphite Ester 2 | 0.07 | 196,585 | −0.0571 | 1.32 |
| 5 | Phosphite Ester 2 | 0.366 | 158,640 | −0.1175 | 2.72 |
| 6 | Phosphite Ester 2 | 3.66 | 205,262 | −0.2614 | 6.05 |
| 7 | Phosphite Ester 3 | 0.365 | 203,618 | −0.0929 | 2.15 |
| 8 | Phosphite Ester 3 | 3.81 | 201,072 | −0.0815 | 1.89 |
| 9 | Phosphite Ester 4 | 0.369 | 210,832 | −0.1017 | 2.35 |
| 10 | Phosphite Ester 4 | 3.58 | 206,729 | −0.1197 | 2.77 |
| 11 | Phosphite Ester 5 | 0.365 | 212,568 | −0.1002 | 2.32 |
| 12 | Phosphite Ester 5 | 3.64 | 207,115 | −0.1118 | 2.59 |
| 13 | Phosphite Ester 6 | 0.07 | 212,741 | −0.0619 | 1.43 |
| 14 | Phosphite Ester 6 | 0.365 | 212,515 | −0.1261 | 2.92 |
| 15 | Phosphite Ester 6 | 3.49 | 226,148 | −0.2031 | 4.70 |
| B* | Phosphite Ester A | 0.365 | 206,876 | −0.0411 | 0.95 |
| C* | Phosphite Ester A | 3.59 | 207,030 | −0.0350 | 0.81 |

*Not an example of the invention.

It is seen from the data in Table 2 that Phosphite Esters 1-6 each provides, at an equivalent phosphorus loading, a much faster rate of hydrolysis than the control (Comparative Sample A). At a phosphorus loading of about 0.36 g/kg, the presence of Phosphite Ester 1 more than triples the rate of hydrolysis under these mild hydrolysis conditions. An even greater acceleration is achieved if the amount of Phosphite Ester is increased to provide 3.65 g P/kg. The hydrolysis rate is nearly doubled even at the very low loading of Example 1. Phosphite Ester 2 is seen to nearly triple the hydrolysis rate at a phosphorus loading of 0.354 g/kg, and to increase it by over six times at a phosphorus loading of 3.65 g/kg.

Phosphite Esters 3-6 also provide significant acceleration of the hydrolysis rate. Phosphite Ester A has no effect on hydrolysis rate.

Another set of hydrolysis experiments is performed in similar manner, except the hydrolysis conditions are 40° C. and 80% RH. Results are as indicated in Table 3.

TABLE 3
Hydrolysis Data in Humidity Chamber at 40° C. and 80% RH

| | | | Starting | Slope | Relative |
|---|---|---|---|---|---|
| | | g | Mw | Ln(Mw)/ | Hydrolysis |
| Sample | Phosphite Additive | P/kg | (g/mol) | day | Rate |
| A* | None | 0 | 208,737 | −0.0046 | 1.00 |
| 1 | Phosphite Ester 1 | 0.07 | 204,910 | −0.0111 | 2.41 |
| 2 | Phosphite Ester 1 | 0.365 | 173,644 | −0.0226 | 4.91 |
| 7 | Phosphite Ester 3 | 0.365 | 203,618 | −0.0212 | 4.61 |
| 9 | Phosphite Ester 4 | 0.369 | 210,832 | −0.0230 | 5.00 |
| 11 | Phosphite Ester 5 | 0.365 | 212,568 | −0.0219 | 4.76 |
| 13 | Phosphite Ester 6 | 0.07 | 212,741 | −0.0120 | 2.61 |
| 14 | Phosphite Ester 6 | 0.365 | 212,515 | −0.0230 | 5.00 |
| B* | Phosphite Ester A | 0.365 | 206,876 | −0.0052 | 1.13 |

*Not an example of the invention.

Under these still milder conditions, Phosphite Esters 1 and 3-6 still provide significant acceleration of hydrolysis rates.

A third set of hydrolysis experiments is performed in similar manner, except the samples are submersed in DI water at 50° C. Results are as indicated in Table 4.

TABLE 4
Hydrolysis Data for Samples Submersed in DI Water at 50° C.

| | | | Starting | Slope | Relative |
|---|---|---|---|---|---|
| | | g | Mw | Ln(Mw)/ | Hydrolysis |
| Sample | Phosphite Additive | P/kg | (g/mol) | day | Rate |
| A* | None | 0 | 208,737 | −0.0506 | 1.00 |
| 1 | Phosphite Ester 1 | 0.07 | 204,910 | −0.0692 | 1.37 |
| 2 | Phosphite Ester 1 | 0.365 | 173,644 | −0.1169 | 2.31 |
| 4 | Phosphite Ester 2 | 0.07 | 196,585 | −0.0614 | 1.18 |
| 5 | Phosphite Ester 2 | 0.366 | 158,640 | −0.1101 | 2.12 |
| 7 | Phosphite Ester 3 | 0.365 | 203,618 | −0.0587 | 1.16 |
| 9 | Phosphite Ester 4 | 0.369 | 210,832 | −0.0606 | 1.20 |
| 11 | Phosphite Ester 5 | 0.365 | 212,568 | −0.0625 | 1.23 |
| 14 | Phosphite Ester 6 | 0.365 | 212,515 | −0.0630 | 1.25 |
| B* | Phosphite Ester A | 0.365 | 206,876 | −0.0487 | 0.96 |

*Not an example of the invention.

This data illustrates the effect of changing from hydrolysis in humid air to hydrolysis in liquid water. Phosphite Ester A has a slightly negative effect on hydrolysis rate. Phosphite Esters 3-6 increase hydrolysis rate slightly. Phosphite Esters 1 and 2 provide very significant increases in the hydrolysis rate under these conditions.

Examples 2 and 9 and Comparative Samples A and C are taken for thermophilic aerobic respirometry (58° C.) according to ASTM D5338-15, as follows.

An inoculum is prepared from a compost having a water content of 45-55% water, obtained from an industrial composting plant, sieved through a 4.76-mm sieve. This compost has an activity within the range of 50 to 150 mg CO₂ per gram of volatile solids over 10 days, per ASTM D5338 § 9.1. It has an ash content of less than 70% and a pH between 7 and 8.2. It has heavy metal contents below the maximum allowable for good microbial health and activity.

Samples of each of Examples 2 and 9 and Comparative Samples A and B are ground and sieved to produce test samples having a particle size of 0.5 to 1.0 mm. 40 g of the test samples are added to 480 g of inoculum and CO2 production is measured over a 90-day period according to the ASTM method. The cumulative CO2 production and absolute biodegradation data are as indicated in Table 5.

TABLE 5
Composting Results after 90 days

| | | | | Absolute |
|---|---|---|---|---|
| | | | Cumulative CO₂ | Biodegra- |
| Sample | Phosphite Additive | g P/kg | production (mg) | dation, % |
| A* | None | 0 | 77,376 | 58.0 |
| 2 | Phosphite Ester 1 | 0.365 | 98,049 | 86.3 |
| 9 | Phosphite Ester 4 | 0.369 | 87,141 | 71.4 |
| B* | Phosphite Ester A | 0.365 | 76,785 | 57.3 |

The blank reactor exhibits a cumulative CO₂ production of 34,741 mg. Absolute biodegradation is calculated from the following equation:

$$\\ Absolute Biodegradation ( \% ) = \frac{{Sample}_{{CO}_{2}}}{sample mass \times carbon content ( \% ) \times 44 / 12}$$

where Sample_{CO2} is calculated accordingly:

Sample_{CO}_{₂}Reactor_{CO}_{₂}−Blank_{CO}_{₂}

For the samples subjected to biodegradation testing, carbon content is 50%.

These results demonstrate that the presence of Phosphite Esters 1 and 4 each greatly accelerates biodegradation under compositing conditions, whereas Phosphite Ester A provides no benefit.

### Examples 17-19 and Comparative Samples D-F

Examples 17-19 and Comparative Samples E and G are prepared by melt-blending PLA Resin 2 or PLA Resin 3 with a phosphite ester compound (as indicated in Table 6) in a twin-screw extruder. The amount of phosphite ester compound is selected to provide phosphorus levels in the product as indicated in Table 6. Comparative Samples D and F are prepared by passing a sample of PLA Resin 2 and PLA Resin 3, respectively, through the twin-screw extruder under the same operating conditions but without any additive.

TABLE 6

| | | Phosphite | | |
|---|---|---|---|---|
| Sample | PLA Resin | Additive | mmol P/kg | g P/kg |
| D* | 2 | None | 0 | 0 |
| E* | 2 | A | 11.8 | 0.366 |
| 16 | 2 | 1 | 11.8 | 0.366 |
| 17 | 2 | 4 | 11.8 | 0.366 |
| F* | 3 | None | 0 | 0 |
| G* | 3 | A | 11.8 | 0.366 |
| 18 | 3 | 1 | 11.8 | 0.366 |
| 19 | 3 | 4 | 11.8 | 0.366 |

*Not an example of the invention.

Examples 16-19 and Comparative Samples D-G each are subjected to hydrolysis at conditions of 50° C. and 80% relative humidity (RH), in the manner as described for the previous examples. Results are as indicated in Table 7.

TABLE 7
Hydrolysis Data in Humidity Chamber at 50° C. and 80% RH

| | | | | Slope | Relative |
|---|---|---|---|---|---|
| | PLA | | g | Ln(M_{w})/ | Hydrolysis |
| Sample | Resin | Phosphite Additive | P/kg | day | Rate¹ |
| C* | 2 | None | 0 | −0.0311 | 1.00 |
| D* | 2 | Phosphite Ester A | 0.366 | −0.0357 | 1.15 |
| 16 | 2 | Phosphite Ester 1 | 0.366 | −0.0895 | 2.88 |
| 17 | 2 | Phosphite Ester 4 | 0.366 | −0.0823 | 2.65 |
| E* | 3 | None | 0.366 | −0.0334 | 1.0 |
| F* | 3 | Phosphite Ester A | 0.366 | −0.0420 | 1.26 |
| 18 | 3 | Phosphite Ester 1 | 0.366 | −0.1307 | 3.91 |
| 19 | 3 | Phosphite Ester 4 | 0.366 | −0.0991 | 2.97 |

*Not an example of the invention.
¹Relative to Sample C, for Comparative Sample D and Examples 16 and 17; relative to Sample E, for Comparative Sample F and Examples 18 and 19.

PLA Resins 2 and 3 are treated with a polyphosphoric acid instead of the polyacrylic acid used to treat PLA Resin 1. The rate of hydrolysis of PLA Resins 2 and 3, when no phosphite ester is present (Samples C and E) is significantly less than that of PLA Resin 1 (Sample A, See Table 2). This indicates that the polyphosphoric acid (or residues thereof) present in PLA Resins 2 and 3 does not facilitate hydrolysis; to the contrary its presence appears to slow the hydrolysis rate by 20% to 30%.

Similar to the results with PLA Resin 1, Phosphite Ester A provides very little increase in hydrolysis rate under these conditions, whereas very significant increases in hydrolysis rate are seen with Phosphite Esters 1 and 4.

Examples 16-19 and Comparative Samples D-G each are subjected to hydrolysis in 50° C. liquid water, in the manner as described for the previous examples. Example 16 is evaluated twice with the average result being reported. Results are as indicated in Table 8.

TABLE 8
Hydrolysis Data for Samples Submersed in DI Water at 50° C.

| | | | | Slope | Relative |
|---|---|---|---|---|---|
| | PLA | | g | Ln(M_{w})/ | Hydrolysis |
| Sample | Resin | Phosphite Additive | P/kg | day | Rate¹ |
| C* | 2 | None | 0 | −0.0435 | 1.00 |
| D* | 2 | Phosphite Ester A | 0.366 | −0.0391 | 0.90 |
| 16 | 2 | Phosphite Ester 1 | 0.366 | −0.0884 | 2.0 |
| 17 | 2 | Phosphite Ester 4 | 0.366 | −0.0393 | 0.90 |
| E* | 3 | None | 0.366 | −0.0384 | 0.88 |
| F* | 3 | Phosphite Ester A | 0.366 | −0.0385 | 1.00 |
| 18 | 3 | Phosphite Ester 1 | 0.366 | −0.0816 | 2.13 |
| 19 | 3 | Phosphite Ester 4 | 0.366 | −0.0422 | 1.10 |

*Not an example of the invention.
¹Relative to Sample C, for Comparative Sample D and Examples 16 and 17; relative to Sample E, for Comparative Sample F and Examples 18 and 19.

As before, the rate of hydrolysis of PLA Resins 2 and 3, when no phosphite ester is present (Samples C and E), is significantly less than that of PLA Resin 1 (Sample A, See Table 4). The presence of polyphosphoric acid (or residues thereof) appears to slow the hydrolysis rate by 14-25% in this test.

Again, it is seen that the performance of the phosphite ester is quite different when the sample is exposed to liquid water rather than merely humid air. Phosphite Ester A has an adverse effect hydrolysis rate under immersion conditions. The presence of Phosphite Ester 1 causes a doubling of the hydrolysis rate. A smaller but still positive increase in hydrolysis rate is seen with Phosphite Ester 4.

### Examples 20 and 21 and Comparative Samples G and H

Examples 20 and 21 and Comparative Sample G are prepared by melt-blending PLA Resin 4 with 1.8 weight-% Phosphite Ester 1, 1 weight-% Phosphite Ester 2 and 1.4 weight-% lauric acid, respectively, in a twin-screw extruder. Comparative Sample H is PLA Resin 4 by itself.

Mass loss of the solid (undissolved) material is performed according to the following protocol. Approximately 2 grams samples, accurately weighed, are added to multiple vials which are also accurately weighed. The vials are then sealed and placed in oven and maintained at 50° C. The vials are removed one-by-one periodically over time. The liquid phase is separated from the remaining solids via decanting, and the vials containing residual solids are then dried to constant weight at 40° C. under vacuum. Mass loss is evaluated from the difference in initial and final weight for each vial as a function of time. The time at which 50% of the starting mass is lost is reported as t_{1/2}. Testing is continued until the 95% of the starting mass of the sample has hydrolyzed and become dissolved in the liquid phase. Results are as indicated in Table 9.

TABLE 9
Hydrolysis Data for Samples Submersed in DI Water at 50° C.

| | | Additive | | Time to 95% |
|---|---|---|---|---|
| Sample | Additive | Amount | t_{1/2}, days | dissolution, days |
| 19 | Phosphite Ester 1 | 1.8% | 9.5 | 19 |
| 20 | Phosphite Ester 1 | 1% | 12 | 20 |
| G* | Lauric Acid | 1.4% | 14.5 | 22 |
| H* | None | N/A | 17.5 | 24 |

*Not an example of the invention.

PLA Resin 4 by itself loses half of its mass in 17.5 days and 95% its mass in 24 days on this test. Adding 1.4% lauric acid, a known hydrolysis accelerant, decreases t_{1/2} by about 17%. Although not shown in Table 9, melt blending higher concentrations of lauric acid to PLA Resin 4 does not decrease t12 significantly.

Adding Phosphite Ester 1 to PLA Resin 4 results in much larger decreases in t_{1/2} (31-43%) than does lauric acid. The 95% hydrolysis in a reduced period of time is an appealing feature to well operators screening degradable diverters.

1. A polylactide resin composition comprising (a) at least one polylactide having a number-average molecular weight as measured by gel permeation chromatography against a polystyrene standard of at least 20,000 g/mol, the polylactide containing (i) 5 to 300 ppm by weight of Group 2-14 metals based on the weight of the polylactide, (ii) 0.1 to 2 parts by weight per 100 parts by weight of the polylactide of (ii-a) a polymer having multiple carboxylic acid, a number average molecular weight of at least 500 g/mol and at least one carboxylic acid group per 250 atomic mass units and/or (ii-b) a polyphosphoric acid which may be partially or completely neutralized, and/or residue thereof and (iii) no more than 0.6 parts by weight of lactide per 100 parts by weight of the polylactide, and (b) at least one phosphite ester compound having a number-average molecular weight of up to 5,000 g/mol, the phosphite ester compound containing 3 to 15% by weight phosphorus and wherein the phosphite ester compound contains, per phosphite phosphorus atom, from zero to one aryl group in which at least one ring carbon ortho to a ring carbon bonded directly to a phosphite oxygen is directly bonded to a tertiary carbon atom of a substituent group, and the polylactide resin composition containing sufficient phosphite ester compound to provide 0.01 to 32 g of phosphorus per kilogram of the polylactide in the polylactide resin composition.

2. The polylactide resin composition of claim 1 wherein the phosphite ester compound is one or more of bis(2,4-di-t-butylphenyl)pentaerythritol diphosphite, bis(2,4-dicumylphenyl) pentaerythritol diphosphite, bis (octadecyl)pentaerythritol diphosphite, triphenyl phosphite, tridecyl phosphite, didecyl phenyl phosphite, phenyl neopentylene glycol phosphite ester and tris(4-nonylphenyl) phosphite.

3. The polylactide resin composition of claim 1 wherein the phosphite ester compound includes at least one at least one polyphosphite ester compound represented by either of structures I and II, wherein structure I is 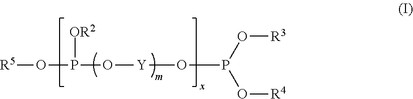
wherein each R², R³, R⁴ and R⁵ can be the same or different and independently selected from the group consisting of C₁₋₂₀ alkyl, C₃₋₂₂ alkenyl, C₆₋₄₀ cycloalkyl, C₇₋₄₀ cycloalkylene, C₁₋₂₀ methoxy alkyl glycol ethers, C₁₋₂₀ alky glycol ethers, and/or Y—OH; Y is selected from the group consisting of C₂₋₄₀ alkylene, C₂₋₄₀ alkyl lactone, —R⁶—N(R⁷)—R⁸— wherein R⁶, R⁷, and R⁸ are independently selected from the group consisting of hydrogen, C₁₋₂₀ alkyl, C₃₋₂₂ alkenyl, C₆₋₄₀ cycloalkyl, C₇₋₄₀ cycloalkylene, C₁₋₂₀ methoxy alkyl glycol ethers, C₁₋₂₀ alky glycol ethers and/or Y—OH, m is an integral value ranging from 2 to 100 and x is an integral value ranging from 1 to 1000; and structure II is 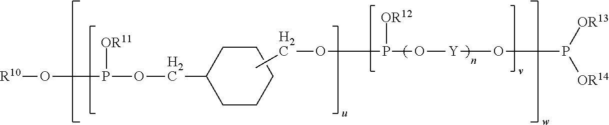
wherein R¹⁰, R¹¹, R¹², R¹³ and R¹⁴ can be the same or different are independently selected from the group consisting of C₁₋₂₀ alkyl, C₂₋₂₂ alkenyl, C₆₋₄₀ cycloalkyl and C₇₀₄_{ₒ} cycloalkenyl; Y is selected from the group consisting of C₂₋₄₀ alkylene, C₂₋₄₀ aliphatic carboxylic acid esters and C₃₋₄₀ cycloalkylenes, n is a number from 5 to 100, u is a number from 8 to 1000, v is a number from 1 to 1000 and w is a number from 1 to 1000.

4. The polylactide resin composition of claim 1 which contains 5 to 300 ppm tin.

5. The polylactide resin composition of claim 1 wherein the polymer having multiple carboxylic acid groups, a number average molecular weight of at least 500 g/mol and at least one carboxylic acid group per 250 atomic mass units is present and is a homopolymer or copolymer of acrylic acid.

6. The polylactide resin composition of claim 1 wherein the polyphosphoric acid or residue thereof is present.

7. A method of making a polylactide resin composition of claim 1, comprising the steps of:
a) polymerizing lactide in the presence of a Group 2-14 metal-containing catalyst to produce a crude polylactide containing 5 to 300 ppm by weight of Group 2-14 metals based on the weight of the polylactide;
b) combining the crude PLA resin with a 0.1 to 2 parts by weight, per 100 parts of the polylactide, of (i) a polymer having multiple carboxylic acid groups, a number average molecular weight of at least 500 g/mol and at least one carboxylic acid group per 250 atomic mass units, and/or (ii) a polyphosphoric acid and/or residue thereof;
c) before, simultaneously with, or after step b), devolatilizing the crude polylactide resin to reduce the lactide concentration to no greater than 0.6% of the combined weight of the polylactide and the remaining lactide and then
d) after step b), combining the PLA resin at least one phosphite ester compound containing 3 to 15% by weight phosphorus and wherein the phosphite ester compound contains, per phosphite phosphorus atom, from zero to one aryl group in which at least one ring carbon ortho to a ring carbon bonded directly to a phosphite oxygen is directly bonded to a tertiary carbon atom of a substituent group, in an amount of sufficient to provide 0.01 to 32 g of phosphorus per kg of the polylactide in the polylactide resin composition.

8. The method of claim 7 wherein the phosphite ester compound is one or more of bis(2,4-di-t-butylphenyl)pentaerythritol diphosphite, bis(2,4-dicumylphenyl) pentaerythritol diphosphite, bis (octadecyl)pentaerythritol diphosphite, triphenyl phosphite, tridecyl phosphite, didecyl phenyl phosphite, phenyl neopentylene glycol phosphite ester and tris(4-nonylphenyl) phosphite.

9. The method of claim 7 wherein the phosphite ester compound includes at least one at least one polyphosphite ester compound represented by either of structures I and II, wherein structure I is 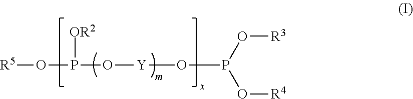
wherein each R², R³, R⁴ and R⁵ can be the same or different and independently selected from the group consisting of C₁₋₂₀ alkyl, C₃₋₂₂ alkenyl, C₆₋₄₀ cycloalkyl, C₇₋₄₀ cycloalkylene, C₁₋₂₀ methoxy alkyl glycol ethers, C₁₋₂₀ alky glycol ethers, and/or Y—OH; Y is selected from the group consisting of C₂₋₄₀ alkylene, C₂₋₄₀ alkyl lactone, —R⁶—N(R⁷)—R⁸— wherein R⁶, R⁷, and R⁸ are independently selected from the group consisting of hydrogen, C₁₋₂₀ alkyl, C₃₋₂₂ alkenyl, C₆₋₄₀ cycloalkyl, C₇₋₄₀ cycloalkylene, C₁₋₂₀ methoxy alkyl glycol ethers, C₁₋₂₀ alky glycol ethers and/or Y—OH, m is an integral value ranging from 2 to 100 and x is an integral value ranging from 1 to 1000; and structure II is 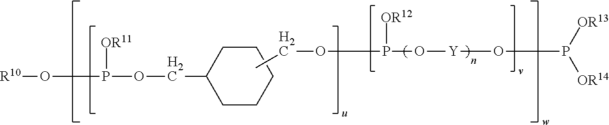
wherein R¹⁰, R¹¹, R¹², R¹³ and R¹⁴ can be the same or different are independently selected from the group consisting of C₁₋₂₀ alkyl, C₂₋₂₂ alkenyl, C₆₋₄₀ cycloalkyl and C₇₀₄_{ₒ} cycloalkenyl; Y is selected from the group consisting of C₂₋₄₀ alkylene, C₂₋₄₀ aliphatic carboxylic acid esters and C₃₋₄₀ cycloalkylenes, n is a number from 5 to 100, u is a number from 8 to 1000, v is a number from 1 to 1000 and w is a number from 1 to 1000.

10. The method of claim 7 wherein the polylactide resin composition contains 5 to 300 ppm tin.

11. The method of claim 7 wherein in step b the crude PLA resin is combined with the polymer having multiple carboxylic acid groups, a number average molecular weight of at least 500 g/mol and at least one carboxylic acid group per 250 atomic mass units.

12. The method of 7 wherein in step b) the crude PLA resin is combined with the polyphosphoric acid.

13. A polylactide resin composition comprising (a) at least one polylactide having a number-average molecular weight as measured by gel permeation chromatography against a polystyrene standard of at least 20,000 g/mol having dissolved or dispersed therein (b) at least one polyphosphite ester compound containing 3.5 to 15% by weight phosphorus and being represented by either of structures I and II, wherein structure I is 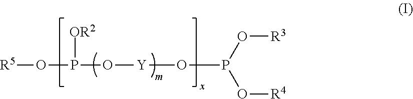
wherein each R², R³, R⁴ and R⁵ can be the same or different and independently selected from the group consisting of C₁₋₂₀ alkyl, C₃₋₂₂ alkenyl, C₆₋₄₀ cycloalkyl, C₇₋₄₀ cycloalkylene, C₁₋₂₀ methoxy alkyl glycol ethers, C₁₋₂₀ alky glycol ethers, and/or Y—OH; Y is selected from the group consisting of C₂₋₄₀ alkylene, C₂₋₄₀ alkyl lactone, —R⁶—N(R⁷)—R⁸— wherein R⁶, R⁷, and R⁸ are independently selected from the group consisting of hydrogen, C₁₋₂₀ alkyl, C₃₋₂₂ alkenyl, C₆₋₄₀ cycloalkyl, C₇₋₄₀ cycloalkylene, C₁₋₂₀ methoxy alkyl glycol ethers, C₁₋₂₀ alky glycol ethers and/or Y—OH, m is an integral value ranging from 2 to 100 and x is an integral value ranging from 1 to 1000; and structure II is 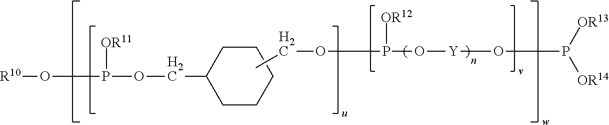
wherein R¹⁰, R¹¹, R¹², R¹³ and R¹⁴ can be the same or different are independently selected from the group consisting of C₁₋₂₀ alkyl, C₂₋₂₂ alkenyl, C₆₋₄₀ cycloalkyl and C₇₀₄_{ₒ} cycloalkenyl; Y is selected from the group consisting of C₂₋₄₀ alkylene, C₂₋₄₀ aliphatic carboxylic acid esters and C₃₋₄₀ cycloalkylenes, n is a number from 5 to 100, u is a number from 8 to 1000, v is a number from 1 to 1000 and w is a number from 1 to 1000,
is (i) a linear or branched C₂ to C₂₄ alkylene group; (ii) a residue, after removal of hydroxyl groups, of a glycol ether or a glycol polyether, a homopolymer or copolymer of ethylene glycol, and/or propylene glycol having 4 or more ether units and formula weights (after removal of hydroxyl groups) of up to 1000 g/mol; and (iii) an o-, m-, or p-dialkyl cyclohexane, in which the alkyl groups have 1 to 4 carbon atoms.

14. A process for hydrolyzing a polylactide resin, comprising immersing a polylactide composition of claim 13 in liquid water at a temperature of 25° C. to 80° C.

15. A process for hydrolyzing a polylactide resin, comprising immersing a polylactide composition of claim 13 in liquid water at a temperature of 25° C.to 80° C.

16. A process for hydrolyzing a polylactide resin, comprising contacting the polylactide composition of claim 13 in air having relative humidity of at least 50% at a temperature of 35° C. to 80° C.

17. A method for treating a subterranean formation comprising a) introducing a treatment fluid containing a liquid phase and particles of the polylactide composition of claim 1 into the subterranean formation, such that a mass of the particles is deposited in the subterranean formation, and then b) hydrolyzing the deposited particles in the subterranean formation by exposing the deposited particles to an aqueous medium and an elevated temperature such that the deposited particles lose at least 50% of their starting mass due to hydrolysis.
